(19) United States
(12) Patent Application Publication
(10) Pub. No.: US 2011/0012782 A1
(43) Pub. Date: Jan. 20, 2011

(54) Apparatus for Location Information Tag of Object and System for Managing Location Information

(76) Inventors: Seungyoup Lee, Seoul (KR); Kyuman Choi, Seoul (KR)

Correspondence Address: Yancy IP Law, PLLC, 5904 Jane Way, Alexandria, VA, 22310, US

(21) Appl. No.: 12/667,354

(22) PCT Filed: Dec. 10, 2008
(86) PCT No.: PCT/KR08/07286

§ 371 Date: Dec. 30, 2009

(30) Foreign Application Priority Data
Dec. 10, 2007 (KR) 10-2007-0127493

(51) Int. Cl. G01S 19/42

(52) U.S. Cl. 342/357.25

(57) ABSTRACT

An object position information tag apparatus, which is attached to an object and transmits position information of the object, includes a global positioning system (GPS) module for receiving a satellite signal from a GSP satellite and calculating the position information of the object and a communication module for transmitting data of the position information being input from the GPS module and a unique identification (ID) code being distinctive for each object to an external device through radio communication. Accordingly, it is possible to effectively recognize positions of products or equipment to which the tag apparatus is attached, regardless of the number and storage place of products or equipment, based on which information regarding movement, storage, and shipping of the open-air stored or stored products or equipment can be collectively gathered and managed.

### TECHNICAL FIELD

The present invention generally relates to an object position information tag apparatus and an object position information management system, and more particularly, to a position information tag apparatus using ZigBee communication and a global positioning system (GPS) module to be suitable for storage, movement, and characteristics of storage goods, and an object position information collection and management system based on the position information tag apparatus. The present invention is intended to solve the foregoing problems and it is an objective of the present invention to provide an apparatus and system for effectively recognizing and managing position information on a large number of products stored in a large place, regardless of an area of the place or the number of products.

This and other objects and advantages of the present invention will be described below and will become apparent by embodiments of the present invention. The object and advantages of the present invention can be achieved by constitutions disclosed in claims and combinations thereof.

### BACKGROUND ART

Among various techniques associated with devices or methods for efficiently managing goods stored in predetermined places or stored in open air, a method of recognizing and utilizing unique information of a stored product by identifying the radio frequency identification (RFID) tag-attached product with a predetermined reader has been widely used.

That method has come into wide use with advantages of the RFID technique, i.e., it can overcome a physical contact between a barcode and a reader and it can record more information than the barcode.

However, although the method overcomes a contact between a product and a reader unlike a barcode scheme, it cannot overcome a one-to-one scheme in which a manager has to carry a reader embedded in equipment, such as a personal digital assistant (PDA), and do a check within a predetermined distance from goods in stock or stored goods.

Moreover, since the product identifying method using the RFID technique is executed in the one-to-one scheme and recognizes only information recorded in a tag, it shows many limitations for use to collectively manage information about product storage positions for a number of storage goods or a large storage place. As a result, the method is mainly used only for a small number of goods or a limited place.

Recently, to solve such a problem regarding acquisition of product position information, a GPS-RFID method has been introduced, which uses a scheme for embedding a GPS module and an RFID tag module in a predetermined device, thus obtaining position information of a product with a reader and obtaining unique information of the product from an RFID tag.

Although the conventional problem regarding acquisition of product position information can be solved to some degree by the GPS-RFID method, a close check scheme using a reader still remains as a problem in terms of dependence upon a human factor such as a manager.

Conventionally disclosed methods for storing and managing goods, including the aforementioned method, do not consider an economical aspect such as efficient power consumption based on a storage place and a number of products, and ignore applicability to a communication infrastructure required for system establishment, resulting in a lack of applicability to the field of industry.

### DISCLOSURE OF INVENTION

### Technical Problem

The present invention is intended to solve the foregoing problems and it is an objective of the present invention to provide an apparatus and system for effectively recognizing and managing position information on a large number of products stored in a large place, regardless of an area of the place or the number of products.

This and other objects and advantages of the present invention will be described below and will become apparent by embodiments of the present invention. The object and advantages of the present invention can be achieved by constitutions disclosed in claims and combinations thereof.

### Technical Solution

To accomplish the above object of the present invention, there is provided an object position information tag apparatus which is attached to an object and transmits position information of the object. The object position information tag apparatus includes a global positioning system (GPS) module for receiving a satellite signal from a GSP satellite and calculating the position information of the object and a communication module for transmitting data of the position information being input from the GPS module and a unique identification (ID) code being distinctive for each object to an external device through radio communication, in which the communication module is preferably a ZigBee module which transmits the data of the position information being input from the GPS module and the unique identification (ID) code being distinctive for each object to the external device through ZigBee communication.

Additionally, for implementation of a preferred embodiment of the present invention, the object position information tag apparatus may further include a received signal strength indication/indicator (RSSI) module for calculating the position information of the object by using the strength of an electric wave received from one or more electric wave transmitters and a control module for controlling the RSSI module to be driven and the ZigBee module to transmit the data of the position information of the RSSI module, if the strength of the satellite signal received by the GPS module is less than a reference strength or an external drive control signal is received.

Preferably, the object position information tag apparatus further includes a motion sensing module for sensing motion of the object, the control module may control conversion of each module from a sleep mode into an activation mode upon input of a motion signal from the motion sensing module, and the object position information tag apparatus may further include a radio frequency identification (RFID) module in which profile information of the object is stored.

It is preferable that the ZigBee module further transmit state information of a power source for driving each module.

According to another aspect of the present invention, there is provided an object position information management system including a tag apparatus comprising a global positioning system (GPS) module for receiving a satellite signal from a GSP satellite and calculating the position information of the object and a ZigBee module for transmitting the data of the position information being input from the GPS module and the unique identification (ID) code being distinctive for each object to the external device through ZigBee communication, a relay device for relaying data transmitted from the tag apparatus to the server 400 through radio communication, and a server for storing and managing the position information of the object and the unique ID code of the object, which have been transmitted from the relay device and are matched with each other, in which the relay device may transmit the data to the server through WiFi communication.

The tag apparatus may further include a radio frequency identification (RFID) module in which profile information of the object is stored, and the object position information management system may further include an RFID reader for reading the profile information from the RFID module of the tag apparatus and transmitting at least one of the read profile information, read time information, or position information of a position where the RFID reader is installed to the server.

Preferably, the ZigBee module of the tag apparatus may further transmit state information of a power source for driving each module, and the server may store state information of the drive power source matched with the position information or unique ID code of the object and output one or more of the stored information through a predetermined screen display means.

To implement a preferred embodiment of the present invention, the server may output one or more of the stored information through the predetermined screen display means by displaying it on a map of a place where the object is stored, or output one or more of the stored information through a predetermined screen display means in such a way that an object stored in a storage place over a predetermined period can be distinguished.

### Advantageous Effects

The object position information tag apparatus and object position information management system according to the present invention can provide effects described below.

First, it is possible to effectively manage various information regarding movement and storage of a large number of objects by collectively managing position information and unique information of the objects.

Second, by effectively converting a module for calculating position information of an object according to the characteristics of a place where the object is located, it is possible to calculate and manage position information of the object regardless of place.

Third, a manager can effectively recognize information on an object and time information regarding time at which the object is stored, thereby allowing substantial management of the object.

Fourth, a module of equipment is activated only at a predetermined period or upon movement of the equipment and thus a feature that the equipment may be stored for a long time in a specific place is taken into account, thereby doubling the efficiency of power consumption.

Fifth, a product stored or stored in open air is matched with map information of the entire open-air storage yard or a storage place, thereby implementing an efficient user interface environment.

### BRIEF DESCRIPTION OF DRAWINGS

The following drawings appended to the specification illustrate the preferred embodiments of the present invention, and act to make the technical spirit of the present invention be understood together with the following detailed description of the invention, and hence, the present invention should not be construed to be limited to those items shown in the drawings, in which:

FIG. 1 is a block diagram showing an object position information tag apparatus according to a preferred embodiment of the present invention;

FIG. 2 is a schematic diagram showing an object position information management system according to another embodiment of the present invention;

FIG. 3 is a block diagram showing a configuration using an RFID tag-added position information tag apparatus according to another embodiment of the present invention;

FIG. 4 illustrates an example of a user interface in the object position information management system according to the preferred embodiment of the present invention; and

FIG. 5 illustrates an example of popped-up detailed product information provided by the user interface.

### BEST MODE FOR CARRYING OUT THE INVENTION

Hereinafter, preferred embodiments of the present invention will be described in detail with reference to the attached drawings. Before doing so, it should be noted that terms and words used in the description and claims are not limited to have merely conventional or dictionary meanings but will be interpreted to have meaning and concept in compliance with the technical spirit of the invention under the principle that the concept of the terms can be properly defined to explain the invention in the best manner. Thus, embodiments disclosed in the description and configuration shown in the accompanying drawings are merely the most preferred those of the various embodiments of the invention and are not to represent all the technical spirit of the invention. Therefore, it will be understood that there may be various equivalences and modifications that are capable of replacing the embodiments present in the description of the invention.

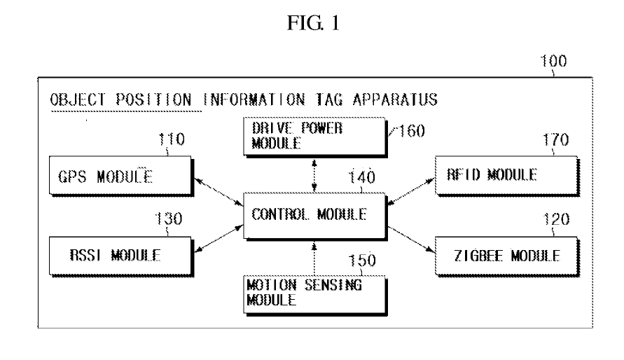

As shown in FIG. 1 which is a block diagram showing a structure of an object position information tag apparatus 100 according to a preferred embodiment of the present invention, the object position information tag apparatus 100 may include a global positioning system (GPS) module 110, a communication (ZigBee) module 120, a received signal strength indication/indicator (RSSI) module 130, a control module 140, a motion sensing module 150, a drive power module 160, and an radio frequency identification (RFID) module 170.

The object position information tag apparatus 100 is attached to an object 10 for which acquisition of position information or relevant information is required. The GPS module 110 included in the object position information tag apparatus 100 is a module for calculating current position information by acquiring reception time and distance information from GPS satellite signals received from three or more satellites and measuring three different distances with the acquired information by means of trian-gulation.

Once the GPS module 110 calculates the position information of the object, the communication module 120 transmits data of the calculated position information of the object and a unique ID code distinctive for each object to which the tag apparatus 100 according to the present invention is attached to an external server through radio communication.

In order to effectively take account of a position relationship between a plurality of tag apparatuses or environmental factors by using a star-type, tree-type, mesh-type network, or ad-hoc network scheme and implement a low-power communication system, it is desirable to use ZigBee communication for the transmission to the external sever.

That is, when the object having the object position information tag apparatus 100 attached thereto stops or moves, the object position information tag apparatus 100 acquires position information of the object by means of GPS and transmits unique ID code data, which is uniquely set for each object to identify the object, together with the acquired position information, to the external server.

The object may include any good or product which is not particularly limited, regardless of a term used to indicate the good or product. To describe a preferred embodiment of the present invention, heavy equipment will be used as an example of the object.

Unlike general vehicles which have no various options and thus are lined out while having the same specification and stored in open air, heavy equipment has various specifications according to oderers needs. In this regard, information about a position where the heavy equipment is stored is very useful.

In other words, when heavy equipment having various specifications, after being lined out, is stored in a large open-air storage yard, an operation of effectively searching for and managing heavy equipment corresponding to a particular order is very important. In this context, the object position information tag apparatus and the position information management system using the same according to the present invention can be effectively used.

Unlike products which are stored in a limited space and positions of which are mostly identified by naked eyes of a manager, storage or open-air storage positions of heavy equipment stored in a large space like an open-air storage yard can be effectively recognized merely by managing data transmitted by the tag apparatus 100 and various management operations can be efficiently performed based on the effective position recognition.

TABLE 1

| | | | Transmitted | Open-Air Storage |
|---|---|---|---|---|
| | Product | Unique ID | Position | Yard |
| # | Specification | Code | Information | Information |
| 1 | A-2-1 Type | 101000000 | (100, 100) | A Zone 11 |
| 2 | B-3-2 Type | 000101100 | (101, 102) | A Zone 01 |
| 3 | C-1 Type | 111010100 | (115, 201) | D Zone 03 |
| [symbol] | [symbol] | [symbol] | [symbol] | [symbol] |
| [symbol] | [symbol] | [symbol] | [symbol] | [symbol] |
| N − 1 | B-2-3 Type | 111110100 | (231, 102) | K Zone 04 |
| N | B-4-1 Type | 111011101 | (111, 120) | C Zone 05 |

Table 1 shows an example where a unique ID code is assigned according to the specification of lined-out equipment and equipment having attached thereto a tag apparatus assigned with the unique ID code is stored in open air.

The leftmost part of Table 1 indicates a serial number and the product specification indicates specification information of a product for identifying heavy equipment manufactured in an original equipment manufacturer (OEM) manner. The unique ID code is an ID code linked with the product specification assigned to the tag apparatus 100 such that it can be distinguished by each product specification. The unique ID code indicates data transmitted from the ZigBee module 120.

The transmitted position information indicates position information calculated by the GPS module 110, and typically, the position information is based on a map coordinate system. For user convenience, the position information may be transformed into a plane coordinate system as shown in Table 1.

Table 1 shows one of various applicable embodiments of the present invention. It is more desirable to provide the position information transmitted by the tag apparatus 100 in the form of information on a zone or position of a open-air storage yard like in the rightmost part of Table 1 so that the position information, previously matched with a management number of the open-air storage yard, can be interfaced to a user than to interface the transmitted position information directly to the user. It is obvious to those of ordinary skill in the art that there may be various applications for generating a database like Table 1.

The aforementioned GPS may vary with a type or function of a used satellite signal, but generally, it may be incapable of determining position information due to blockage of a GPS signal in a GPS shadow area such as a building-dense area, woods, a tunnel, an indoor environment, or the like.

A product such as heavy equipment to which the position information tag apparatus 100 is attached may be moved to an indoor environment such as into a factory line. Also in this case, an RSSI system according to another embodiment of the present invention may be used to effectively determine the position of the heavy equipment having the tag apparatus attached thereto.

That is, the RSSI module 130 calculates position information of the object by using the strength of electric waves received from one or more electric wave transmitters. The RSSI module 130 corresponds to a module for calculating information about a position thereof by using the intensities or strengths of a plurality of received signals.

It is desirable to include the control module 140 for controlling the RSSI module 130 to be driven and the ZigBee module 120 to transmit data of position information of the RSSI module 130, if the strength of a satellite signal received by the GPS module 110 is less than a reference strength or an external drive control signal is received.

The control module 140 controls conversion from the GPS module 110 into the RSSI module 130 for calculation of data of the position information if a signal received by the GPS module 110 is weaker than a predetermined reference signal, thereby effectively calculating the position of the position information tag apparatus 100 even in the GPS shadow area.

For dynamic driving of the tag apparatus 100 as necessary, the control module 140 is preferably configured to allow the conversion even when an RF control signal or an external drive control signal using ZigBee communication is received.

Actually, a place where heavy equipment is stored or stored in open air has a very large area and a large amount of heavy equipment may remain stored in open air for a considerable period until shipping to an orderer. In this environment, the economical efficiency of power consumption is crucial in the above-described object management system.

Thus, power consumption of each module of the tag apparatus 100 can be minimized by controlling position information of heavy equipment to be transmitted at every predetermined period, and it is more efficient to transmit data of position information only in a condition where heavy equipment having the tag apparatus 100 attached thereto is lined out and then moved to the open-air storage yard or the storage place of the heavy equipment is changed, so that a substantial environment requiring the position information can be reflected more.

In other words, data transmitted immediately prior to final stop of heavy equipment may be recognized as a place where the heavy equipment is actually stored in open air, and even when the storage position is changed or the heavy equipment is moved into a factory for inspection or repair, the position of heavy equipment is transmitted in real time from the start of the movement, thereby providing high efficiency in management of the heavy equipment.

For maximization of power consumption efficiency, in another embodiment of the present invention, the motion sensing module 150 for sensing motion of the object is further included in the tag apparatus 100 and the control module 140 is configured to control conversion of each module from a sleep mode to an activation mode upon input of a motion signal from the motion sensing module 150.

The motion sensing module 150 preferably uses a mechanical or physical sensor such as a gyro sensor or an acceleration sensor rather than an electronic sensor, so as not to be another component consuming power. Once the motion sensing module 150 transmits the motion signal, the control module 140 controls each module to be converted from the sleep mode to the activation mode, in which the activation mode means a state where driving of each module described is performed normally.

The sleep mode means a sort of standby state where power supplied by the drive power module 160 is blocked and only minimum power required by each module is supplied. The sleep mode should be understood as a concept including various applications for reducing power consumption according to an embodiment.

In addition, it is desirable to transmit power state information of the drive power module 160 for driving each module to a server 400 so that monitoring of power state and exchange predictability can be possible.

The object position information tag apparatus 100 according to the present invention may further include the RFID module 170 which may be configured to record specification information or profile information of heavy equipment having the tag apparatus 100 attached thereto such that a manager can check an identity of equipment by reading the recorded information when inspecting open-air stored equipment.

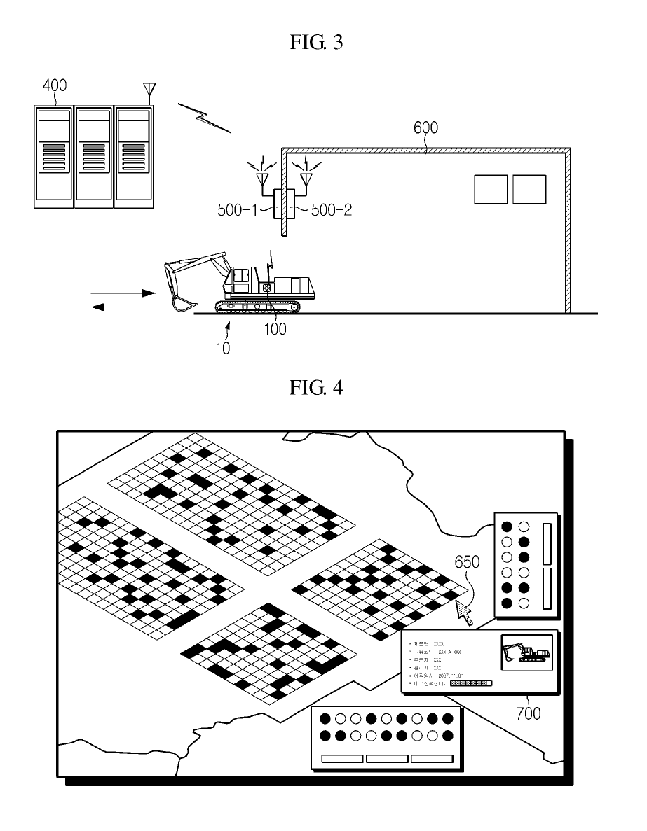

As shown in FIG. 3 which illustrates a configuration using the position information tag apparatus 100 having an RFID tag added thereto according to another embodiment of the present invention, when a physical occupying space is changed like when heavy equipment is shipped or lined out from a factory 600, the heavy equipment passes through a gate and readers 500-1 and 500-2 are installed in the gate, thereby acquiring information of the moving heavy equipment.

### MODE FOR THE INVENTION

The acquired information is transmitted, together with the read time information or position information regarding a position where the RFID reader is installed, to the server 400 according to the present invention, thereby providing effective management of heavy equipment whose physical occupying space is changed. As shown in FIG. 3,

when a plurality of readers are installed in indoor and outdoor environments, the moving direction of the heavy equipment can also be acquired by using a difference between the read time information regarding times at which the outdoor reader 500-1 and the indoor reader 500-2 read the information, respectively.

When the present invention is described, each component of the tag apparatus 100 according to the present invention and the management system described below should be understood as logically separated components rather than physically separated components.

That is, since each constitution corresponds to a logical component for implementing the technical spirit of the present invention, components, even when integrated or separated, should be interpreted as falling within the scope of the present invention as long as functions executed by logical constitutions of the present invention can be achieved. Components performing the same or similar function should be interpreted as falling within the scope of the present invention regardless of an identity of names.

Hereinafter, a detailed description will be made regarding an object position information management system using the object position information tag apparatus 100 according to another aspect of the present invention.

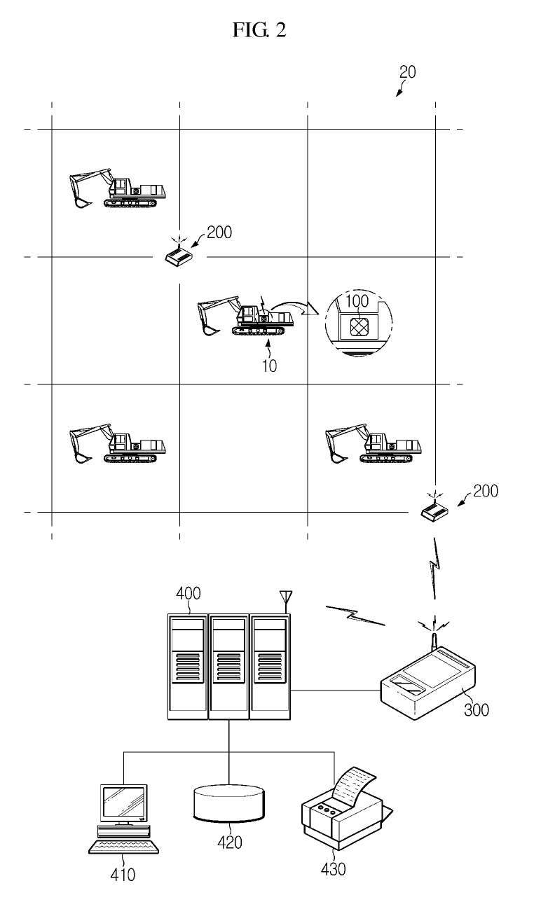

As shown in FIG. 2, the object position information management system includes the tag apparatus 100, a relay device 200, an information collection device 300, and the server 400.

As described previously, the tag apparatus 100 includes a GPS module for receiving a satellite signal from a GPS satellite and calculating position information of an object from the satellite signal and a ZigBee module for transmitting data of the position information being input from the GPS module and a unique ID code distinctive for each object to an external device through ZigBee communication.

The relay device 200 relays data transmitted from the tag apparatus 100 to the server 400, and there may be a plurality of relay devices according to the number of tag apparatuses, an area of an open-air storage yard, the degree of radio interference, or the radio environment. If necessary, the relay device 200 may be configured to transmit the data to the server 400 through intervention of the information collection device 300. For the data transmission of the relay device 200, a radio communication scheme using ZigBee communication or a WiFi communication scheme may be selectively used, taking account of many complex factors such as an environment where the relay device 200 is installed, a relationship with the server 400, or power utilization.

Therefore, the relay apparatus 200 should be interpreted as a concept including a bridge module such as the information collection device 300, without being limited to a term indicating the relay apparatus 200 such as a router module or a gate module, and any component should be understood as the same component as the relay device 200 as long as it performs a function of transmitting data transmitted from the tag apparatus 100 to the server 400.

The server 400 according to the present invention stores and manages the position information of the object transmitted from the relay device 200 and the unique ID code of the object, which are matched with each other.

As shown in FIG. 2, the server 400 may be configured such that it is connected to a manager interface 410, a short message service (SMS) sever 420, or an output device 430 to collectively perform various functions required for management.

In an embodiment, the server 400 analyzes data transmitted from each tag apparatus, and if a malfunction, such as a failure in data transmission, occurs or check and inspection of open-air stored heavy equipment by naked eyes are required, the server 400 is configured to send a message indicating that fact to a mobile communication terminal of the operator through an SMS server connected to the server 400, thereby allowing dynamic and substantial management.

The server 400 is preferably configured to generate a database like Table 1, interface and output the generated database suitably for a user environment, and output state information of a power source of each tag apparatus, together with data of Table 1.

Moreover, to prevent objects from being left for a long period after stored in an open-air storage yard and to allow a management operation such as periodic inspection to be performed, it is desirable to output the database through interfacing such as application of a distinctive color or a flickering effect such that an object stored for a predetermined period without movement can be distinguished.

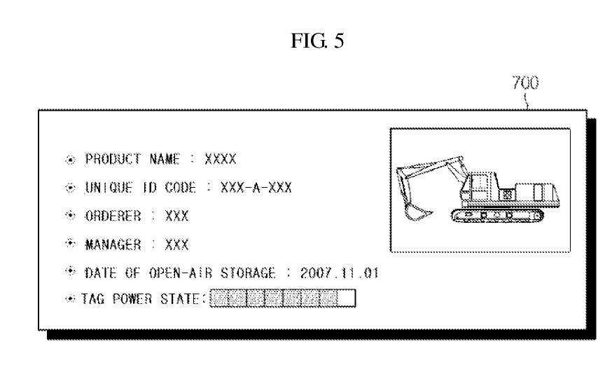

The server 400 may be configured to display position information of the object on map data of the entire open-air storage yard as shown in FIGS. 4 and 5, whereby collective and overall management efficiency can be improved.

In an embodiment of the present invention, if a mouse point 650 points to a particular spot (shadow square area) where heavy equipment is stored in open air in an open-air storage output screen being output together with open-air storage yard map information, relevant information on corresponding heavy equipment and corresponding tag apparatus may be provided to a user through a predetermined popup window 700.

While the present invention has been described with reference to limited embodiments and drawings, the present invention is not limited by the embodiments and drawings and various modifications and changes can be made by those of ordinary skill in the art within the technical spirit of the present invention and a scope equivalent to the appended claims.

### INDUSTRIAL APPLICABILITY

The object position information tag apparatus and object position information management system according to the present invention can provide effects described below.

First, it is possible to effectively manage various information regarding movement and storage of a large number of objects by collectively managing position information and unique information of the objects.

Second, by effectively converting a module for calculating position information of an object according to the characteristics of a place where the object is located, it is possible to calculate and manage position information of the object regardless of place.

Third, a manager can effectively recognize information on an object and time information regarding time at which the object is stored, thereby allowing substantial management of the object.

Fourth, a module of equipment is activated only at a predetermined period or upon movement of the equipment and thus a feature that the equipment may be stored for a long time in a specific place is taken into account, thereby doubling the efficiency of power consumption.

Fifth, a product stored or stored in open air is matched with map information of the entire open-air storage yard or a storage place, thereby implementing an efficient user interface environment.

1. An object position information tag apparatus which is attached to an object and transmits position information of the object, the object position information tag apparatus comprising: a global positioning system (GPS) module for receiving a satellite signal from a GSP satellite and calculating the position information of the object; and a communication module for transmitting data of the position information being input from the GPS module and a unique identification (ID) code being distinctive for each object to an external device through radio communication.

2. The object position information tag apparatus of claim 1, wherein the communication module is a ZigBee module which transmits the data of the position information being input from the GPS module and the unique identification (ID) code being distinctive for each object to the external device through ZigBee communication.

3. The object position information tag apparatus of claim 2, further comprising: a received signal strength indication/indicator (RSSI) module for calculating the position information of the object by using the strength of an electric wave received from one or more electric wave transmitters; and a control module for controlling the RSSI module to be driven and the ZigBee module to transmit the data of the position information of the RSSI module, if the strength of the satellite signal received by the GPS module is less than a reference strength or an external drive control signal is received.

4. The object position information tag apparatus of claim 3, further comprising a motion sensing module for sensing motion of the object, wherein the control module controls conversion of each module from a sleep mode into an activation mode upon input of a motion signal from the motion sensing module.

5. The object position information tag apparatus of claim 1, further comprising a radio frequency identification (RFID) module in which profile information of the object is stored.

6. The object position information tag apparatus of claim 2, wherein the ZigBee module further transmits state information of a power source for driving each module.

7. An object position information management system comprising: a tag apparatus comprising a global positioning system (GPS) module for receiving a satellite signal from a GSP satellite and calculating the position information of the object and a ZigBee module for transmitting the data of the position information being input from the GPS module and the unique identification (ID) code being distinctive for each object to the external device through ZigBee communication; a relay device for relaying data transmitted from the tag apparatus to the server 400 through radio communication; and a server for storing and managing the position information of the object and the unique ID code of the object, which have been transmitted from the relay device and are matched with each other.

8. The object position information management system of claim 7, wherein the relay device relays the data to the server through WiFi communication.

9. The object position information management system of claim 8, wherein the tag apparatus further comprises: a received signal strength indication/indicator (RSSI) module for calculating the position information of the object by using the strength of an electric wave received from one or more electric wave transmitters; and a control module for controlling the RSSI module to be driven and the ZigBee module to transmit the data of the position information of the RSSI module, if the strength of the satellite signal received by the GPS module is less than a reference strength or an external drive control signal is received.

10. The object position information management system of claim 9, wherein the tag apparatus further comprises a motion sensing module for sensing motion of the object, wherein the control module controls conversion of each module from a sleep mode into an activation mode upon input of a motion signal from the motion sensing module.

11. The object position information management system of claim 7, wherein the tag apparatus further comprises a radio frequency identification (RFID) module in which profile information of the object is stored, and the object position information management system further comprises an RFID reader for reading the profile information from the RFID module of the tag apparatus and transmitting at least one of the read profile information, read time information, or position information of a position where the RFID reader is installed to the server.

12. The object position information management system of claim 7, wherein the ZigBee module of the tag apparatus further transmits state information of a power source for driving each module, and the server stores state information of the drive power source matched with the position information or unique ID code of the object and outputs one or more of the stored information through a predetermined screen display means.

13. The object position information management system of claim 12, wherein the server outputs one or more of the stored information through the predetermined screen display means by displaying it on a map of a place where the object is stored.

14. The object position information management system of claim 13, wherein the server outputs one or more of the stored information through a predetermined screen display means in such a way that an object stored in a storage place over a predetermined period can be distinguished.
